(19) United States
(12) Patent Application Publication
(10) Pub. No.: US 2019/0222689 A1
(43) Pub. Date: Jul. 18, 2019

(54) ELECTRONIC DEVICE AND CONTROL DEVICE

(71) Applicant: SHARP KABUSHIKI KAISHA, Sakai City (JP)

(72) Inventor: MASATOSHI NOMA, Sakai City (JP)

(21) Appl. No.: 16/236,448

(22) Filed: Dec. 29, 2018

(30) Foreign Application Priority Data
Jan. 12, 2018 (JP) 2018-003659

(51) Int. Cl. H04M 1/725

(52) U.S. Cl. CPC H04M 1/72563

(57) ABSTRACT

The present invention makes it possible to properly detect contact with an object even in a case where a contact detecting device continues to react despite not being in contact with the object. A control device includes: a detecting device control section configured to determine whether or not a condition is satisfied, the condition including (i) a state where an output value of the contact detecting device exceeds a predetermined contact threshold value and (ii) a variation in the output value falls within a predetermined range within a predetermined period after the output value exceeded the predetermined contact threshold value; and a calibration processing section configured to perform, in a case where it is determined that the condition is satisfied, at least one of the following processes (a) and (b) so as to prevent contact with an object from being detected at the output value outputted during the predetermined period: (a) a process of calibrating an output value of the contact detecting device and (b) a process of changing the predetermined contact threshold value.

This Nonprovisional application claims priority under 35 U.S.C. § 119 on Patent Application No. 2018-003659 filed in Japan on Jan. 12, 2018, the entire contents of which are hereby incorporated by reference.

### TECHNICAL FIELD

The present invention relates to an electronic device and a control device.

### BACKGROUND ART

Conventionally, there has been a technique in which a process to be carried out by an electronic device such as a smartphone is decided according to detection results obtained by a sensor provided in the electronic device. Patent Literature 1 discloses an information processing device including a contact sensor which detects that a user's hand is in contact with an electrode provided so as to come into contact with the user's hand while the user is holding the information processing device at a holding part.

### CITATION LIST

### Patent Literature

[Patent Literature 1]

Japanese Patent Application Publication Tokukai No. 2015-211455 (Publication date: Nov. 24, 2015)

### SUMMARY OF INVENTION

### Technical Problem

In a case of a sensor (contact sensor) such as that disclosed in Patent Literature 1 which determines a value of a physical quantity that varies depending on how an object is making contact, the value of the physical quantity while the object is not making contact may change according to a change in surrounding environment. For example, in a case where a casing is deformed due to falling, pressure, or change over time, a contact sensor may remain pressured. This may cause an output of the contact sensor to continue exceeding a threshold which is set in advance. In this case, the contact sensor may unfortunately continue to react even while the device is not being held.

An aspect of the present invention has been made in view of the problem, and its object is to achieve an electronic device or the like which is capable of properly detecting contact with an object even in a case where a contact detecting device continues to react despite not being in contact with the object.

### Solution to Problem

In order to attain the object, an electronic device in accordance with an aspect of the present invention is an electronic device including: at least one contact detecting device configured to detect contact with an object; and a control device configured to control an operation of the at least one contact detecting device, the control device being configured to: determine whether or not a condition is satisfied, the condition including (i) a state where an output value of the at least one contact detecting device exceeds a predetermined contact threshold value and (ii) a variation in the output value falls within a predetermined range within a predetermined period after the output value exceeded the predetermined contact threshold value; and in a case where it is determined that the condition is satisfied, perform at least one of the following processes (a) and (b) so as to prevent contact with an object from being detected at the output value outputted during the predetermined period: (a) a process of calibrating an output value of the at least one contact detecting device and (b) a process of changing the predetermined contact threshold value.

In order to attain the object, a control device in accordance with an aspect of the present invention is a control device for controlling an electronic device, the electronic device including: at least one contact detecting device configured to detect contact with an object, the control device including: a determination section configured to determine whether or not a condition is satisfied, the condition including (i) a state where an output value of the at least one contact detecting device exceeds a predetermined contact threshold value and (ii) a variation in the output value falls within a predetermined range within a predetermined period after the output value exceeded the predetermined contact threshold value; and a calibrating section configured to perform, in a case where it is determined that the condition is satisfied, at least one of the following processes (a) and (b) so as to prevent contact with an object from being detected at the output value outputted during the predetermined period: (a) a process of calibrating an output value of the at least one contact detecting device and (b) a process of changing the predetermined contact threshold value.

### Advantageous Effects of Invention

An aspect of the present invention brings about such an effect that it is possible to properly detect contact with an object even in a case where a contact detecting device continues to react despite not being in contact with the object.

### BRIEF DESCRIPTION OF DRAWINGS

FIG. 1 is a block diagram schematically illustrating a configuration of an electronic device in accordance with an embodiment of the present invention.

FIG. 2 illustrates an appearance of the electronic device.

FIG. 3 is a view for describing an operation of the electronic device.

FIG. 4 is a flowchart showing an example of a flow of the operation of the electronic device.

FIG. 5 is a flowchart showing another example of the flow of the operation of the electronic device.

FIG. 6 is a view for describing an operation of the electronic device.

FIG. 7 is a flowchart showing yet another example of the flow of the operation of the electronic device.

### DESCRIPTION OF EMBODIMENTS

### Embodiment 1

The following description will discuss an embodiment of the present invention in detail. Note that descriptions of configurations, which are described in specific items (embodiments) below but are identical with those described in the other items, may be omitted. For convenience, members having the same functions as those described in different items are given the same reference signs and their descriptions will be omitted.

The electronic device specified herein can be any device having a portion to be held by a user. Examples of such an electronic device include a smartphone, a mobile phone, a tablet terminal, a remote control, a hair dryer, and a vacuum cleaner.

[Electronic Device]

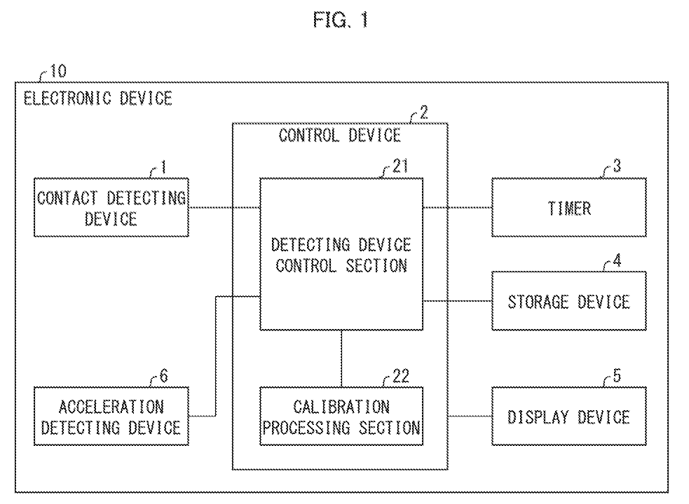

The following description will discuss an example in which an electronic device 10 is a smartphone. However, the electronic device 10 is not limited to such a device. As illustrated in FIG. 1, the electronic device 10 includes a contact detecting device 1, a control device 2, a timer 3, a storage device 4, a display device 5, and an acceleration detecting device 6.

The contact detecting device 1 can mainly detect that the contact detecting device 1 is being held by a user. The contact detecting device 1 can be, for example, a device for determining the degree of pressure applied or a device for detecting a distortion or warp of the electronic device 10 caused by a change in pressure. More specifically, the contact detecting device 1 can be a sensor for detecting contact with an object such as a user's hand. Examples of the sensor include a pressure sensor, a piezoelectric sensor, and an electrostatic sensor (3D force sensor).

The control device 2 centrally controls individual sections of the electronic device 10. In Embodiment 1, the control device 2 particularly includes a detecting device control section (determination section) 21 and a calibration processing section (calibrating section) 22. Functions of the detecting device control section 21 and the calibration processing section 22 are described in detail later.

The timer 3 measures time. The timer 3 can be realized by, for example, a real time clock (RTC) integrated circuit (IC) for measuring time. Further, the timer 3 is configured, by way of example, so as to supply a notification signal (alarm) to the detecting device control section 21 when a predetermined amount of time has elapsed since time measurement started in response to an instruction from the detecting device control section 21.

The storage device 4 stores various types of data and various types of programs. The storage device 4 can be configured by, for example, a non-volatile storage device such as a hard disk, a flash memory, and a ROM. In the storage device 4, data is stored in advance. Examples of the data include: (i) a reference value that is an output value outputted by the contact detecting device 1 while the contact detecting device 1 is not in contact with an object or the like, (ii) a contact threshold value concerning an output value of the contact detecting device 1, (iii) an acceleration threshold value concerning an output value of the acceleration detecting device 6, and (iv) a derivative threshold value concerning a derivative value of an output value of the contact detecting device 1. The detecting device control section 21 can read and write these values from/into the storage device 4.

The reference value indicates a sensor value while the casing is not held by a user. The contact threshold value is a threshold value for determining whether or not the contact detecting device 1 is in contact with an object. The contact threshold value is set in accordance with the reference value. The acceleration threshold value is a threshold value for determining the occurrence of a rapid change in speed of the electronic device 10 which change takes place, for example, in a case where the electronic device 10 is dropped or hit by a foreign matter. The derivative threshold value is a threshold value for determining the occurrence of a rapid change in output value of the electronic device 10 which change takes place, for example, in a case where the electronic device 10 is dropped or hit by a foreign matter.

For the display device 5, for example, a liquid crystal panel is used. Note that a display panel to be used for the display device 5 is not limited to the liquid crystal panel but can be an organic electroluminescence (EL) panel, an inorganic EL panel, a plasma panel, or the like. The acceleration detecting device 6 detects an acceleration of the electronic device 10.

The detecting device control section 21 controls operations of both the contact detecting device 1 and the acceleration detecting device 6. In particular, the detecting device control section 21 determines whether or not the following two conditions (1) and (2) are satisfied:

(1) The output value of the contact detecting device 1 exceeds a predetermined contact threshold value.
(2) After the output value exceeded the contact threshold value, variations in the output value were settled in a predetermined range within a predetermined period.

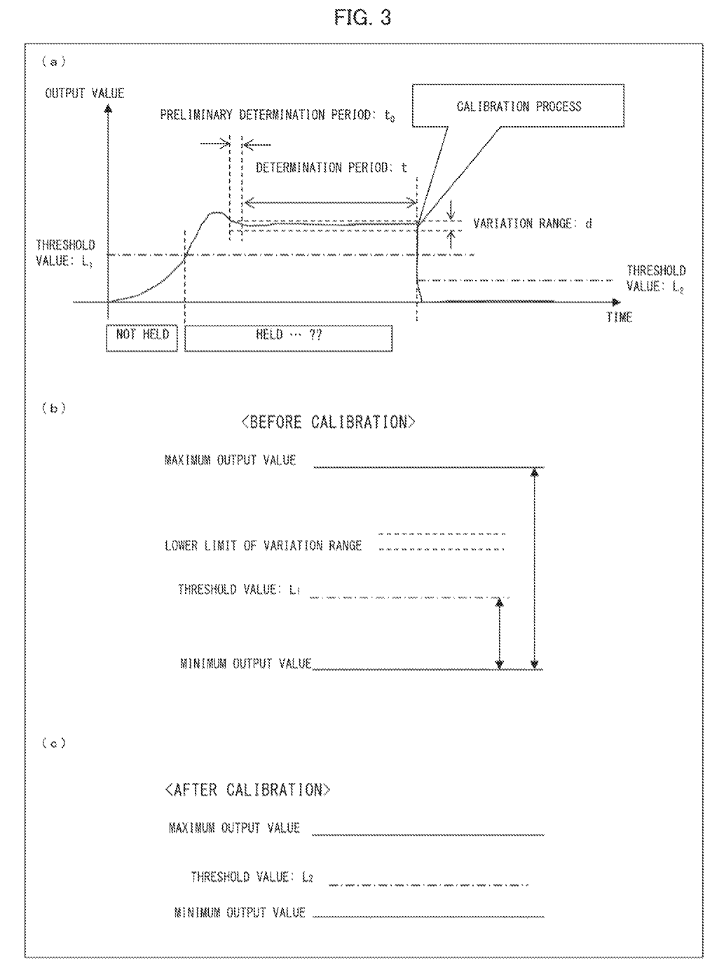

Note that the term “within a predetermined range” refers to a state where, as illustrated in (a) of FIG. 3, an output value falls within a range having (i) a certain lower limit and (ii) an upper limit which is higher than the lower limit by a variation range d.

In a case where it is determined that the conditions (1) and (2) are satisfied, the calibration processing section 22 calibrates a reference value of an output value of the contact detecting device (i.e., performs a calibration process).

The calibration processing section 22 performs calibration of the reference value. More specifically, in a case where the contact detecting device 1 continues to receive a contact pressure due to deformation of the casing or the like, the calibration processing section 22 updates the reference value so that the output value of the contact detecting device 1 becomes zero or substantially zero in such a state. The calibration processing section 22 thus calibrates the output value of the contact detecting device 1.

In other words, the calibration processing section 22 re-adjusts, as a reference value (indicative of a state in which the contact detecting device 1 is not receiving a pressure), the output value of the contact detecting device 1 outputted as a result of, for example, deformation of the casing. Therefore, upon and after completion of the re-adjustment, contact with an object can be detected as was detected before the deformation of the casing.

In a case where the conditions (1) and (2) are satisfied, it is considered that the electronic device 10 is not being held by a user but is continuing to receive a physical pressure, due to, for example, deformation of the casing of the electronic device 10. In such a case, the contact detecting device 1 continues reacting despite not being in contact with an object. Even in this case, calibrating an output value of the contact detecting device 1 makes it possible to properly detect contact with an object.

In a case where the acceleration detecting device 6 has detected an acceleration greater than a predetermined acceleration threshold value, the control device 2 can start a process of determining whether or not an output value of the contact detecting device 1 has exceeded a predetermined contact threshold value. In addition, in a case where a derivative value of an output value of the contact detecting device 1 is greater than a predetermined derivative threshold value, the control device 2 can start a process of determining whether or not the output value of the contact detecting device 1 has exceeded a predetermined contact threshold value. With any of these configurations, it is possible to properly detect contact with an object by performing a suitable calibration process as necessary, in a case where, for example, it is highly likely that an electronic device was dropped or was hit by a foreign matter.

It is also possible that in a case where the calibration processing section 22 has calibrated the output value of the contact detecting device 1, the calibration processing section 22 changes a contact threshold value so that the contact threshold value is lower. This reduces a possibility that the contact detecting device reacts less reliably despite being in contact with an object. This makes it possible to properly detect contact with an object.

Assume a case where (i) an output value of the contact detecting device 1 exceeds a predetermined contact threshold value and (ii) variations in the output value fall within a predetermined range within a predetermined period after the output value exceeded the predetermined contact threshold value. In this case, it can be considered that, for example, the electronic device 10 is not being held by a user but is in a state in which the contact detecting device 1 is continuing to receive a physical pressure due to, for example, deformation of a casing 7 of the electronic device 10. Therefore, the electronic device 10 is configured as described above so that in such a state, at least one of the following processes (a) and (b) is performed so as to prevent contact with an object from being detected at the output value outputted during a predetermined period: (a) a process of calibrating an output value of the contact detecting device 1 and (b) a process of changing the predetermined contact threshold value. This makes it possible to properly detect contact with an object even in a state such as that described above.

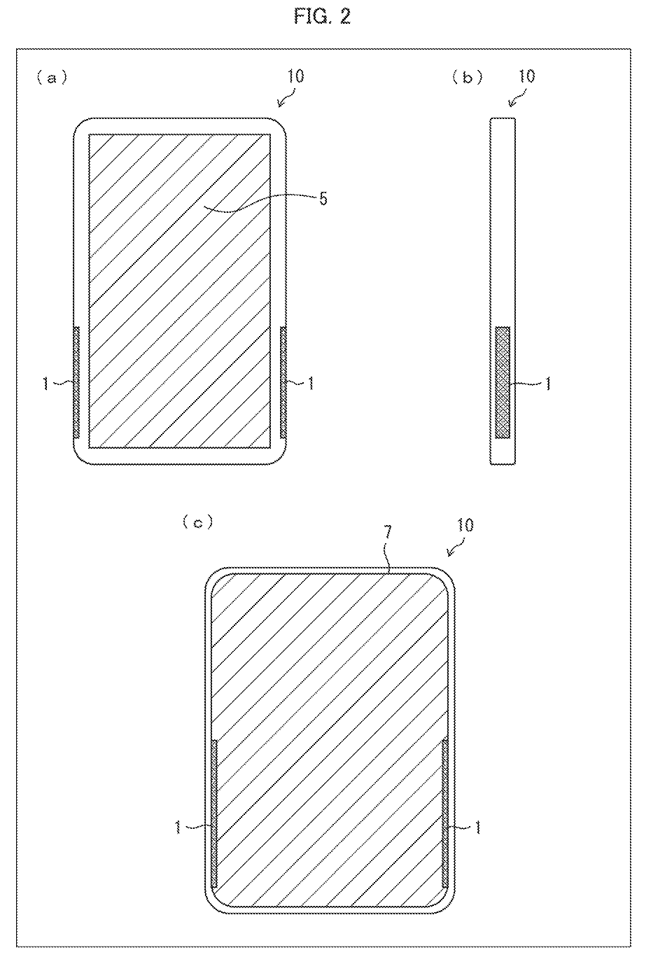

FIG. 2 is a schematic view illustrating an appearance of the electronic device 10 in accordance with Embodiment 1. The electronic device 10 includes the display device 5 (e.g., a touch panel) provided on at least one surface of the casing. Note that the surface on which the display device 5 is provided as illustrated in (a) of FIG. 2 will be referred to as a “front surface” of the electronic device 10. The electronic device 10 also includes contact detecting devices 1 provided so as to come into contact with a user's hand which holds the casing of the electronic device 10.

As illustrated in (a) and (b) of FIG. 2, the electronic device 10 includes, for example, two contact detecting devices 1 provided on respective two surfaces adjacent to the long sides of the front surface (hereinafter the two surfaces will be referred to as “side surfaces” of the electronic device 10). Note that the number and layout of contact detecting devices 1 are not limited to those illustrated in (a) and (b) of FIG. 2. For example, a plurality of contact detecting devices 1 can be provided on each of the side surfaces. Alternatively, a contact detecting device 1 can be provided over the entire side surface.

Moreover, the contact detecting device 1 can be exposed to the outside of the casing. Alternatively, the contact detecting device 1 can be provided inside a casing 7 as illustrated in (c) of FIG. 2. In other words, it is only necessary to provide the contact detecting device 1 so as to correspond to a user's hand which holds the casing 7. Other than these examples, the contact detecting device 1 can be provided, for example, below a power button/volume button/“Home” button (not illustrated), or below the display panel (touch panel).

(a) of FIG. 3 is a graph showing a relationship between (i) an output value of the contact detecting device 1 and (ii) time. A threshold value L₁ is an example of a contact threshold value for determining whether or not an object is in contact with the contact detecting device 1. A preliminary determination period to is used for determining whether or not variations in the output value of the contact detecting device 1 have been settled. In a case where the variations have fallen within a variation range d within the preliminary determination period to, it is determined that the variations have been restrained.

Subsequently, a determination period t is used for determining whether or not a user is holding the electronic device 10. In a case where variations in the output value of the contact detecting device 1 have fallen within a variation range d over the determination period t, it is determined that a user is not holding the electronic device 10. Meanwhile, in a case where there is a variation in the output value which variation falls outside the variation range d during the determination period t, it is determined that a user is holding the electronic device 10. This is because the output value is considered to vary by a certain amount or more while a user is touching the contact detecting device 1 (holding the electronic device 10). Specifically, it can be determined that a user is holding the electronic device 10 in a case where (i) the output value of the contact detecting device 1 exceeds a threshold value L₁ (contact threshold value) which is set in advance and (ii) the output value continues to vary by a certain amount or more over a certain period.

(b) of FIG. 3 shows a relationship, before calibration, between (i) a maximum value of an output value of the contact detecting device 1, (ii) a variation range, (iii) a threshold value L₁, and (iv) a minimum value of the output value of the contact detecting device 1. Meanwhile, (c) of FIG. 3 shows a relationship, after the calibration, between (i) a maximum value of the output value of the contact detecting device 1, (ii) a threshold value L₂ which is a new threshold, and (iv) a minimum value of the output value of the contact detecting device 1.

[First Operation Example of Operation of Electronic Device]

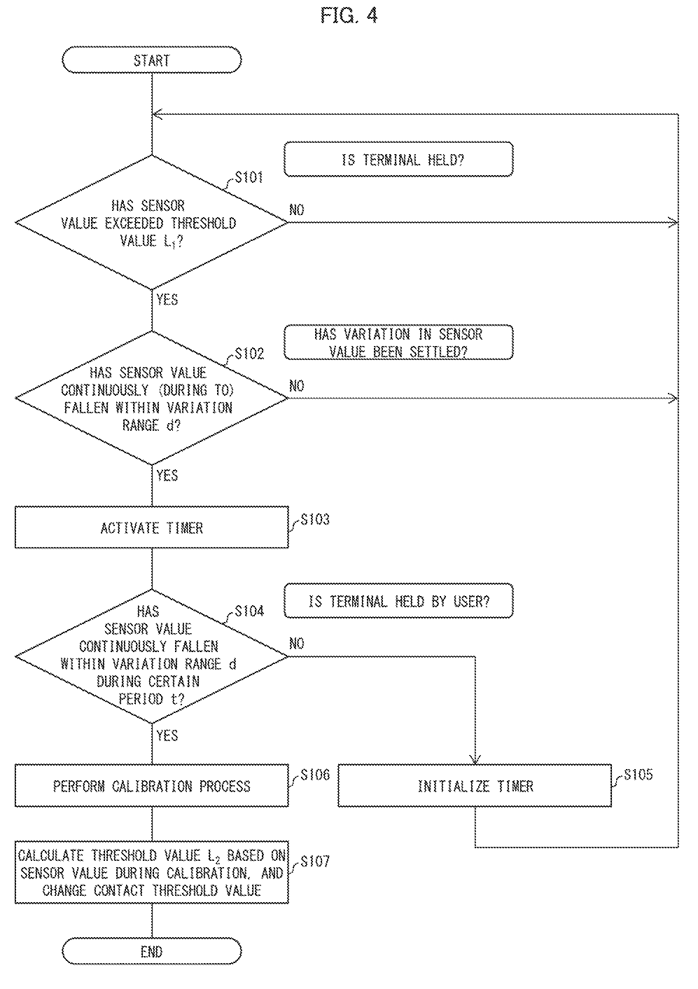

Next, a first operation example of an operation of the electronic device 10 will be described with reference to a flowchart of FIG. 4. Following a start of use of the electronic device 10, the process proceeds to Step S101 (hereinafter the term “Step” will be omitted).

In S101, the detecting device control section 21 determines whether or not an output value of the contact detecting device 1 (such a value will be hereinafter referred to as “sensor value”) has exceeded a threshold value L₁. This corresponds to determining whether or not the electronic device 10 (terminal) has been held. In so doing, in a case where the sensor value exceeds the threshold value L₁, the process proceeds to S102. Meanwhile, in a case where the sensor value is not less than the threshold value L₁, the process returns to S101.

In S102, the detecting device control section 21 determines whether or not variations in the sensor value have continuously fallen within the variation range d (over the preliminary determination period to). This corresponds to determining whether or not the variations have been settled. In a case where the variations have continuously fallen within the variation range d over the preliminary determination period t₀ in S102, the process proceeds to S103. Meanwhile, in a case where there is a variation in the sensor value which variation falls outside the variation range d during the preliminary determination period t₀ in S102, the process returns to S101. In S103, the detecting device control section 21 activates the timer 3, and the process proceeds to S104.

In S104, the detecting device control section 21 determines whether or not the variations in the sensor value have fallen within the variation range d over a certain period (the determination period t). This corresponds to determining whether or not a user is holding the electronic device 10. In a case where the variations in the sensor value have fallen within the variation range d over the certain period (the determination period t) in S104, the process proceeds to S106. Meanwhile, in a case where there is a variation in the sensor value which variation falls outside the variation range d during the determination period t in S104, the process proceeds to S105. In S105, the timer 3 is initialized, and the process returns to S101.

In S106, the calibration processing section 22 performs calibration. Specifically, the calibration processing section 22 changes a reference value of the contact detecting device so as to calibrate the sensor value. Then, the process proceeds to S107. For example, the calibration processing section 22 can calculate an average of sensor values outputted during the determination period t and set the average as a new reference value. In S107, the threshold value L₂ is calculated based on the sensor values during the calibration, and the threshold value L₂ thus calculated is used as a new contact threshold value. This ends the process of FIG. 4.

Note that the procedure in S107 (i.e. changing the threshold value) is not essential. However, it is preferable to set the threshold value to a value lower than the original threshold value L₁ because, in a case where the calibration is performed, the contact detecting device 1 is continuing to receive a pressure. In addition, the threshold value L₂ after changing of the threshold value can be inversely proportional to the sensor value during the calibration (i.e., a higher sensor value leads to a lower threshold value L₂).

[Second Operation Example of Operation of Electronic Device]

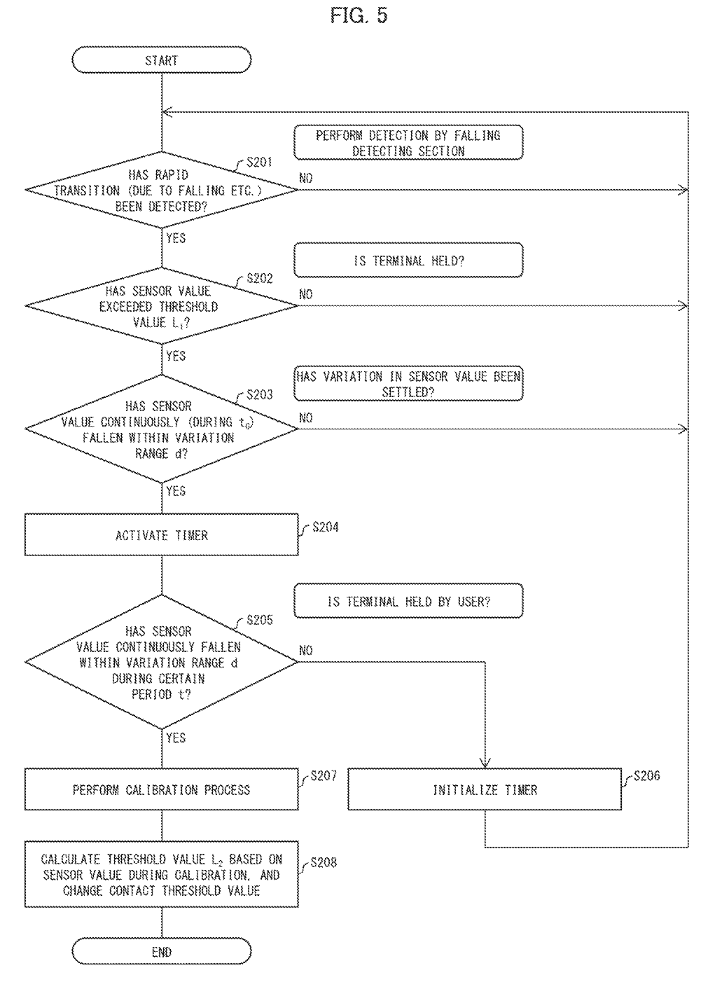

Next, a second operation example of an operation of the electronic device 10 will be described with reference to a flowchart of FIG. 5. The flowchart of FIG. 5 differs from the flowchart of FIG. 4 in that S201 is added before S202 which corresponds to an operation in S101 of the flowchart of FIG. 4. Note that operations in S202 through S208 correspond to the operations in S101 through S107 of the flowchart of FIG. 4, and therefore will not be described below. Only an operation in S201 will be described below.

In S201, whether or not a rapid transition (due to, for example, falling of the electronic device 10) has been detected is determined by the detecting device control section 21 according to an output value of the acceleration detecting device 6 (i.e. based on whether or not an acceleration has exceeded a predetermined acceleration threshold value). This corresponds to determining by the acceleration detecting device 6 (falling detecting section) of whether or not the electronic device 10 has been, for example, dropped. In a case where the rapid transition of the electronic device 10 is detected in S201, the process proceeds to S202. Meanwhile, in a case where the rapid transition of the electronic device 10 is not detected, the process returns to S201.

[Third Operation Example of Operation of Electronic Device]

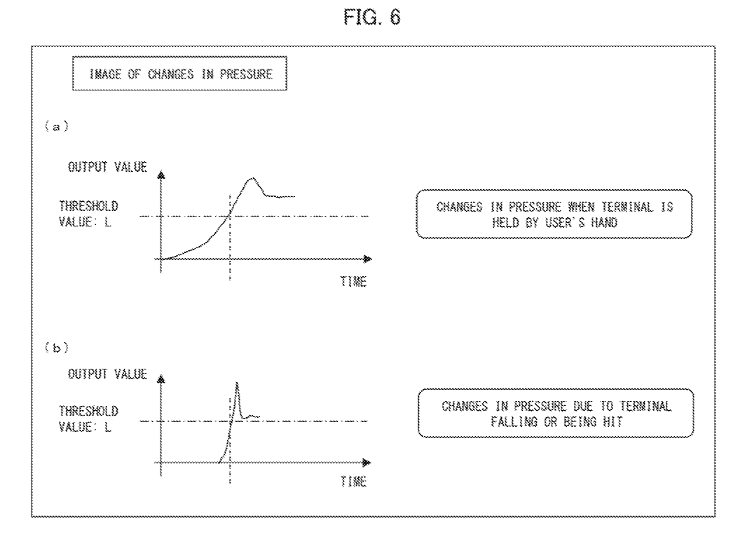

FIG. 6 is a conceptual view showing changes in pressure. (a) and (b) of FIG. 6 are graphs each showing a relationship between (i) an output value of the contact detecting device 1 and (ii) time. Specifically, (a) of FIG. 6 is a graph showing pressure changes which occur in a case where the electronic device 10 is held by a user's hand. (b) of FIG. 6 is a graph showing pressure changes which occur in a case where the electronic device 10 is dropped or hit by a foreign matter.

According to the graph of (a) of FIG. 6, the output value of the contact detecting device 1 changes relatively slowly after exceeding a threshold value L (contact threshold value). Meanwhile, according to the graph of (b) of FIG. 6, the output value of the contact detecting device 1 changes relatively rapidly after exceeding the threshold value L (contact threshold value). Hence, calculating a derivative value of the output value of the contact detecting device 1 makes it possible to determine, in accordance with the calculated derivative value, whether (i) the electronic device 10 is held by a user or (ii) the electronic device 10 is dropped or hit by a foreign matter.

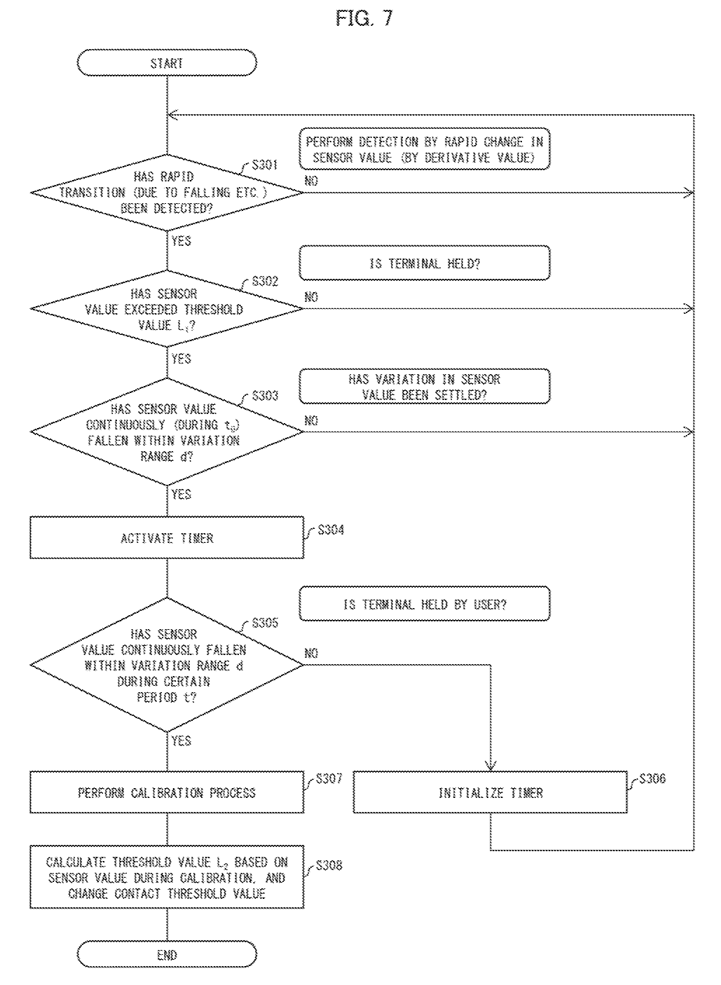

Next, a third operation example of an operation of the electronic device 10 will be described with reference to a flowchart of FIG. 7. The flowchart of FIG. 7 differs from the flowchart of FIG. 4 in that S301 is added before S302 which corresponds to an operation in S101 of the flowchart of FIG. 4. Note that operations in S302 through S308 correspond to the operations in S101 through S107 of the flowchart of FIG. 4, and therefore will not be described below. Only an operation in S301 will be described below.

In S301, the detecting device control section 21 calculates a derivative threshold value of an output value of the contact detecting device 1. Then, based on whether or not there has been a rapid change in sensor value (i.e. whether or not the derivative value has exceeded a predetermined derivative threshold value), the detecting device control section 21 determines whether or not a rapid transition (due to, for example, falling of the electronic device 10) has been detected. This corresponds to determining, based on a rapid change (derivative value) in sensor value of the contact detecting device 1, whether or not the electronic device 10 has been, for example, dropped. In a case where the rapid transition of the electronic device is detected in S301, the process proceeds to S302.

Meanwhile, in a case where the rapid transition of the electronic device 10 is not detected, the process returns to S301.

### Embodiment 2

A calibration processing section 22 can change a contact threshold value instead of calibrating an output value of the contact detecting device 1 through changing a reference value. The contact threshold value is changed to a value that prevents contact with an object from being detected by reference to a value outputted during a determination period t as illustrated in (a) of FIG. 3. This makes it possible to properly detect, as in Embodiment 1, contact with an object even while the contact detecting device 1 is continuing to receive a physical pressure. For example, the calibration processing section 22 can (i) calculate an average of sensor values outputted during a determination period t, (ii) add, to the average, a threshold value L₂ which has been calculated as in Embodiment 1, and (iii) set the resultant value as a new contact threshold value.

### Embodiment 3: Software Implementation Example

Control blocks of the control device 2 (particularly the detecting device control section 21 and the calibration processing section 22) of the electronic device 10 can be realized by a logic circuit (hardware) provided in an integrated circuit (IC chip) or the like or can be realized by software.

In the latter case, the control device 2 includes a computer that executes instructions of a program that is software realizing the foregoing functions. The computer includes, for example, at least one processor (control device) and at least one storage medium in which the program is stored so as to be readable by the computer. An object of the present invention can be achieved in a case where the processor of the computer reads and executes the program stored in the storage medium. Examples of the processor encompass a Central Processing Unit (CPU). Examples of the storage medium encompass “a non-transitory tangible medium” such as a Read Only Memory (ROM) or the like, a tape, a disk, a card, a semiconductor memory, and a programmable logic circuit. The control device 2 can further include a Random Access Memory (RAM) or the like in which the program is loaded. The program can be supplied to or made available to the computer via any transmission medium (such as a communication network or a broadcast wave) which allows the program to be transmitted. Note that an aspect of the present invention can also be achieved in the form of a computer data signal in which the program is embodied via electronic transmission and which is embedded in a carrier wave.

[Recap]

An electronic device (10) in accordance with Aspect 1 of the present invention is an electronic device including: at least one contact detecting device (1) configured to detect contact with an object; and a control device (2) configured to control an operation of the at least one contact detecting device, the control device being configured to: determine whether or not a condition is satisfied, the condition including (i) a state where an output value of the at least one contact detecting device exceeds a predetermined contact threshold value and (ii) a variation in the output value falls within a predetermined range within a predetermined period after the output value exceeded the predetermined contact threshold value; and in a case where it is determined that the condition is satisfied, perform at least one of the following processes (a) and (b) so as to prevent contact with an object from being detected at the output value outputted during the predetermined period: (a) a process of calibrating an output value of the at least one contact detecting device and (b) a process of changing the predetermined contact threshold value.

Assume a case where (i) an output value of the contact detecting device exceeds a predetermined contact threshold value and (ii) variations in the output value fall within a predetermined range within a predetermined period after the output value exceeded the predetermined contact threshold value. In this case, it can be considered that, for example, the electronic device is not being held by a user but is in a state in which the contact detecting device is continuing to receive a physical pressure due to, for example, deformation of a casing of the electronic device. Therefore, the electronic device is configured as described above so that in such a state, at least one of the following processes (a) and (b) is performed so as to prevent contact with an object from being detected at the output value outputted during a predetermined period: (a) a process of calibrating an output value of the contact detecting device and (b) a process of changing the predetermined contact threshold value. This makes it possible to properly detect contact with an object even in a state such as that described above.

In Aspect 2 of the present invention, the electronic device in accordance with Aspect 1 can further include: an acceleration detecting device (6) configured to detect an acceleration of the electronic device, the control device being configured so that in a case where the acceleration detecting device has detected an acceleration greater than a predetermined acceleration threshold value, the control device starts a process of determining whether or not an output value of the at least one contact detecting device has exceeded a predetermined contact threshold value. With the configuration, it is possible to properly detect contact with an object even in a case where the electronic device has been damaged because, for example, the electronic device was dropped or hit by a foreign matter.

In Aspect 3 of the present invention, the electronic device in accordance with Aspect 1 can be configured so that in a case where a derivative value of an output value of the at least one contact detecting device is greater than a predetermined derivative threshold value, the control device starts a process of determining whether or not the output value of the at least one contact detecting device has exceeded a predetermined contact threshold value. With the configuration, it is possible to properly detect contact with an object even in a case where the electronic device has been damaged because, for example, the electronic device was dropped or hit by a foreign matter.

In Aspect 4 of the present invention, the electronic device in accordance with any one of Aspects 1 through 3 can be configured so that in a case where the control device has performed the process (a) of calibrating the output value of the at least one contact detecting device, the control device changes the predetermined contact threshold value so that the contact threshold value is lower. The configuration reduces a possibility that the contact detecting device reacts less reliably despite being in contact with an object. This makes it possible to properly detect contact with an object.

A control device (2) in accordance with Aspect 5 of the present invention is a control device for controlling an electronic device (10), the electronic device including: at least one contact detecting device (1) configured to detect contact with an object, the control device including: a determination section (detecting device control section 21) configured to determine whether or not a condition is satisfied, the condition including (i) a state where an output value of the at least one contact detecting device exceeds a predetermined contact threshold value and (ii) a variation in the output value falls within a predetermined range within a predetermined period after the output value exceeded the predetermined contact threshold value; and a calibrating section (calibration processing section 22) configured to perform, in a case where it is determined that the condition is satisfied, at least one of the following processes (a) and (b) so as to prevent contact with an object from being detected at the output value outputted during the predetermined period: (a) a process of calibrating an output value of the at least one contact detecting device and (b) a process of changing the predetermined contact threshold value. With the configuration, it is possible to achieve a control device which makes it possible to properly detect contact with an object.

The control device in accordance with each of the foregoing aspects of the present invention can be realized by a computer. In such a case, the scope of the present invention also encompasses: (i) a control program for controlling the control device, which control program causes a computer to operate as each section (software element) included in the control device so that the control device can be achieved by the computer; and (ii) a computer-readable storage medium in which the control program is stored.

### ADDITIONAL REMARKS

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 Contact detecting device
2 Control device
3 Timer
4 Storage device
5 Display device
6 Acceleration detecting device
7 Casing
10 Electronic device
21 Detecting device control section (determination section)
22 Calibration processing section (calibrating section)

1. An electronic device comprising:
at least one contact detecting device configured to detect contact with an object; and
a control device configured to control an operation of the at least one contact detecting device,
the control device being configured to:
determine whether or not a condition is satisfied, the condition including (i) a state where an output value of the at least one contact detecting device exceeds a predetermined contact threshold value and (ii) a variation in the output value falls within a predetermined range within a predetermined period after the output value exceeded the predetermined contact threshold value; and
in a case where it is determined that the condition is satisfied, perform at least one of the following processes (a) and (b) so as to prevent contact with an object from being detected at the output value outputted during the predetermined period: (a) a process of calibrating an output value of the at least one contact detecting device and (b) a process of changing the predetermined contact threshold value.

2. The electronic device as set forth in claim 1, further comprising:
an acceleration detecting device configured to detect an acceleration of the electronic device,
the control device being configured so that in a case where the acceleration detecting device has detected an acceleration greater than a predetermined acceleration threshold value, the control device starts a process of determining whether or not an output value of the at least one contact detecting device has exceeded a predetermined contact threshold value.

3. The electronic device as set forth in claim 1, wherein
in a case where a derivative value of an output value of the at least one contact detecting device is greater than a predetermined derivative threshold value, the control device starts a process of determining whether or not the output value of the at least one contact detecting device has exceeded a predetermined contact threshold value.

4. The electronic device as set forth in claim 1, wherein
in a case where the control device has performed the process (a) of calibrating the output value of the at least one contact detecting device, the control device changes the predetermined contact threshold value so that the contact threshold value is lower.

5. A control device for controlling an electronic device,
said electronic device comprising:
at least one contact detecting device configured to detect contact with an object,
said control device comprising:
a determination section configured to determine whether or not a condition is satisfied, the condition including (i) a state where an output value of the at least one contact detecting device exceeds a predetermined contact threshold value and (ii) a variation in the output value falls within a predetermined range within a predetermined period after the output value exceeded the predetermined contact threshold value; and
a calibrating section configured to perform, in a case where it is determined that the condition is satisfied, at least one of the following processes (a) and (b) so as to prevent contact with an object from being detected at the output value outputted during the predetermined period: (a) a process of calibrating an output value of the at least one contact detecting device and (b) a process of changing the predetermined contact threshold value.
